(19) United States
(12) Patent Application Publication
(10) Pub. No.: US 2024/0129117 A1
(43) Pub. Date: Apr. 18, 2024

(54) METHOD FOR ENCRYPTION KEY GENERATION AND AUTHENTICATION BASED ON GAIT CHARACTERISTICS

(71) Applicant: KONGJU NATIONAL UNIVERSITY INDUSTRY-UNIVERSITY COOPERATION FOUNDATION, Gongju-si (KR)

(72) Inventors: Lam Ha Tran, Gongju-si (KR); Hyunil Kim, Daejeon (KR); Changho Seo, Daejeon (KR); Deokjai Choi, Gwangju (KR)

(21) Appl. No.: 18/144,816

(22) Filed: May 8, 2023

(30) Foreign Application Priority Data
Oct. 13, 2022 (KR) 10-2022-0131308

(51) Int. Cl. H04L 9/08; G06V 40/20

(52) U.S. Cl. CPC H04L 9/0866; G06V 40/25; H04L 9/0822

(57) ABSTRACT

Provided is a method for encryption key generation and authentication, based on a gait characteristic. In the method for encryption key generation and authentication, based on a gait characteristic, gait data for the gait of a user is received from a user terminal, a user encryption key for each user is generated with respect to each service, based on the gait data, authentication encryption key is generated based on gait data to be authenticated, the user encryption key is compared with the authentication encryption key, the user is authenticated, when the user encryption key matches the authentication encryption key.

### BACKGROUND OF THE INVENTION

### 1. Field of the Invention

The present invention relates to a method for encryption key generation and authentication, based on a gait characteristic. More particularly, the present invention relates to a method for encryption key generation and authentication, based on a gait characteristic, capable of receiving gait data on the gait of a user from a user terminal, of generating a user encryption key for each user with respect to each service, based on the gait data, of generating an authentication encryption key based on gait data to be authenticated, of comparing the user encryption key and the authentication encryption key, of authenticating a user, when the user encryption key matches the authentication encryption key.

### 2. Description of the Related Art

Biometrics extensively indicates a scheme of recognizing a person, based on at least one intrinsic physical characteristic or behavior characteristic. The physical characteristic used for the biometrics may include a fingerprint, a face, or a vein, and the behavior characteristic used for the biometrics may include a voice, a signature, or a gait.

In particular, the gait shows a walking pattern varied for each person, due to the physical characteristic or a motion characteristic of the person. As the gait is analyzed, a “forensic gait” may be derived. The forensic gait is recognized as a direct evidence in a court.

In other words, the gait shows the characteristic for each person. Accordingly, it is obvious that analyzing the gait is a scientific scheme sufficient to specify one individual.

When the gait is measured, it is difficult to derive data values completely identical to each other every time. Accordingly, there is required a method for specifying a user by receiving gait data of the user and extracting characteristic data for the gait of the user, based on the gait data.

Meanwhile, the authentication of the user employs a scheme of inputting an authentication key for security, in the use of various services such as access to a web-site, mobile payment, or mobile remittance. The authentication for each service which employs one authentication key, is weak for security. Accordingly, there is required a method for generating an authentication key for each service, based on characteristic data of a user.

### SUMMARY OF THE INVENTION

Accordingly, an object of the present invention is to provide a method for encryption key generation and authentication, based on a gait characteristic. More particularly, the present invention relates to a method for encryption key generation and authentication, based on a gait characteristic, capable of receiving gait data for the gait of a user from a user terminal, of generating a user encryption key for each user with respect to each service, based on the gait data, of generating an authentication encryption key based on gait data to be authenticated, of comparing the user encryption key and the authentication encryption key, of authenticating a user, when the user encryption key matches the authentication encryption key.

According to one embodiment of the present invention, there is provided a method for encryption key generation and authentication for each service, based on a gait characteristic for each person, which includes a data receiving step of receiving gait data on a gait of a user from a user terminal including an acceleration sensor and a gyro-sensor, in which the gait data includes data of the acceleration sensor for each time with respect to a plurality of axes and data of the gyro-sensor for the each time with respect to the plurality of axes, a pre-processing step of pre-processing the gait data to generate pre-processed gait data, a characteristic data deriving step of deriving characteristic data by inputting the pre-processed gait data into a first inference model based on a convolutional neural network (CNN) and a second inference model based on a long short term-memory (LSTM), a random projection step of randomly generating a random projection matrix for the characteristic data with respect to the each service and the each user, and multiplying the random projection matrix by the characteristic data to generate first user random data, an encoding step of encoding the first user random data based on a preset first rule and encoding an encoded result value based on a preset second rule to generate second user random data, a random data generating step of encoding first random data, which is randomly generated and has a string form, based on a preset third rule to generate second random data, and generating encryption random data by inputting the first random data and third random data, which is randomly generated and has a string form, into a first encryption function, and a key generating step of generating encryption seed data by inputting seed data, which is extracted from the second random data and the second user random data based on a preset fourth rule, into a second encryption function and generating a user encryption key based on the encryption seed data and the encryption random data.

According to one embodiment of the present invention, the method for encryption key generation and authentication, based on the gait characteristic may further include the encryption key authenticating step. The encryption key authenticating step may include an authentication-gait receiving step of receiving gait data to be authenticated with respect to the gait of a user, from the user terminal, an authentication data generating step of generating authentication second user random data by processing the gait data, which is to be authenticated, through the pre-processing step, the characteristic data deriving step, the random projection step, and the encoding step, an authentication second random data generating step of generating authentication second random data by inputting the authentication second user random data and the encryption seed data into a first decryption function, an authentication encryption key generating step of extracting authentication first random data by decoding the authentication second random data based on a preset fifth rule, and generating the authentication encryption key by inputting the authentication first random data and the encryption random data into a second encryption function, and a user authentication step of determining a user as being the same user, when the authentication encryption key matches the user encryption key.

According to an embodiment of the present invention, data of the acceleration sensor may include acceleration information, data of the gyro-sensor may include rotational angle information, and the pre-processed gait data may include data obtained by extracting an acceleration for each of an X axis, a Y axis, and a Z axis according to time slots, from the acceleration information, and data obtained by extracting a rotational angle for each of the X axis, the Y axis, and the Z axis according to time slots, from the rotational angle information.

According to an embodiment of the present invention, the first rule may be to encode a value, which is contained in the user random data, to ‘1’ when the value is greater than ‘0’, and to encode the value, which is contained in the user random data, to ‘0’, when the value is equal to or less than ‘0’.

According to an embodiment of the present invention, the second rule may be to sequentially determine two pieces of data, which is contained in the user random data, in pair and to encode the user random data to ‘0’ to ‘3’, depending on the combination of the two pieces of data

According to an embodiment of the present invention, the fourth rule may be configured to extract data at a relevant position of the seed data as the second user random data at the relevant position when the second random data is ‘1’, and may be configured to extract the data at the relevant position of the seed data as random data when the second random data is ‘0’.

As described above, according to an embodiment of the present invention, in the random data generating step and the key generating step, the characteristic data may have irreversibility. Accordingly, the characteristic data is not extracted through the user encryption key including the encryption seed data and the encryption random data, thereby protecting the biometrics of the user.

According to an embodiment of the present invention, the characteristic data having the intrinsic characteristic for the gait of the user and/or an intrinsic directionality for the gait of the user may be generated through the first inference model and the second inference model. Accordingly, the authentication encryption key and the user encryption key may be generated in match with each other, for the same user.

According to an embodiment of the present invention, a different random projection matrix is multiplied by the characteristic data, with respect to each service. Accordingly, the plurality of user encryption keys may be generated by using the characteristic data, instead of one user encryption key, thereby enhancing the security.

According to an embodiment of the present invention, since the characteristic data is input into the inference model and the encoding function, the user encryption key, which is generated through the pre-processing step, the characteristic data deriving step, the random projection step, the encoding step, and the random data generating step, may appear to be a random number.

### BRIEF DESCRIPTION OF THE DRAWINGS

FIGS. 1A and 1B are views schematically illustrating a method for encryption key generation and authentication for each service and each user, based on a gait characteristic according to an embodiment of the present invention.

FIGS. 2A and 2B are views schematically illustrating a data receiving step and a pre-processing step according to an embodiment of the present invention.

FIG. 3 is a view schematically illustrating a characteristic data deriving step, a random projection step, and an encoding step according to an embodiment of the present invention.

FIG. 4 is a view schematically illustrating a random data generating step and a key generating step according to an embodiment of the present invention.

FIG. 5 is schematically illustrating a random data generating step and a key generating step according to an embodiment of the present invention.

FIGS. 6A and 6B are views schematically illustrating an encryption key authenticating step according to an embodiment of the present invention.

FIG. 7 is a view schematically illustrating an encryption key authenticating step according to an embodiment of the present invention.

FIG. 8 schematically shows internal components of the computing device according to one embodiment of the present invention.

### DETAILED DESCRIPTION OF THE INVENTION

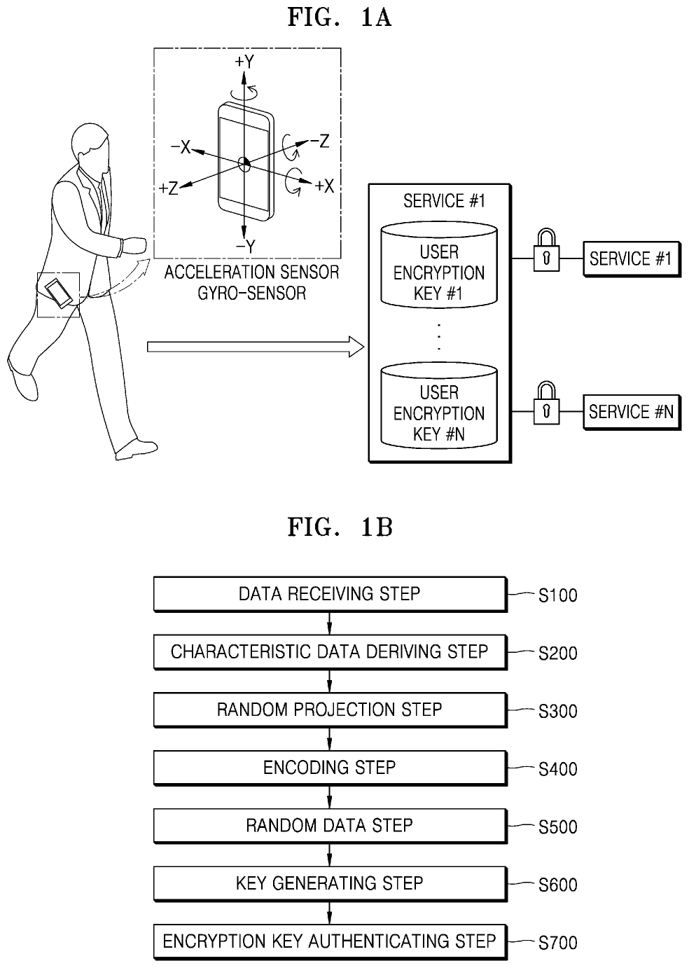

FIGS. 1A and 1B are views schematically illustrating a method for encryption key generation and authentication for each service and each user, based on a gait characteristic according to an embodiment of the present invention.

FIG. 1A is a view schematically illustrating a method for encryption key generation and authentication for each service and each user, based on a gait characteristic.

As illustrated in FIG. 1A, according to the method for encryption key generation and authentication for each service and each user, characteristic data on a gait of a user is received from a user terminal 1000 to generate a user encryption key for each service.

In detail, a user has the user terminal 1000 attached to the body of the use, and the user terminal 1000 moves depending on the gait of the user. The user terminal 1000 may generate gait data measured by an acceleration sensor and a gyro-sensor included in the user terminal 1000.

The gait of the user may be varied due to the stride, the walking speed, a degree to which a spine is bent, a degree of stiffness in the body, the rotation angle of an upper body and pelvis, an angle at which a foot is facing out, an angle between a heel, an ankle, and a calf, the presence of an “0” leg, and an “X” leg, or the ratio (pressure distribution) of left and right feet touching the ground surface (pressure distribution). Accordingly, the gait data measured by the acceleration sensor and the gyro-sensor of the user terminal 1000 may be varied depending on users. In other words, the gait data may include the intrinsic directionality for each user.

According to the method for encryption key generation and authentication for each service and each user, when any user uses a plurality of services, the user may generate a user encryption key unique to each service, based on the gait data. In other words, the user encryption key for a specific service cannot be used as a user encryption key for another service. Accordingly, higher security may be maintained.

FIG. 1B is a view schematically illustrating detailed steps in the method for encryption key generation and authentication for each service and each user, based on the gait characteristic.

According to one embodiment of the present invention, there is provided a method for encryption key generation and authentication for each service, based on a gait characteristic for each person, which includes a data receiving step of receiving gait data on a gait of a user from a user terminal including an acceleration sensor and a gyro-sensor, in which the gait data includes data of the acceleration sensor for each time with respect to a plurality of axes and data of the gyro-sensor for the each time with respect to the plurality of axes, a pre-processing step of pre-processing the gait data to generate pre-processed gait data, a characteristic data deriving step of deriving characteristic data by inputting the pre-processed gait data into a first inference model based on a convolutional neural network (CNN) and a second inference model based on a long short term-memory (LSTM), a random projection step of randomly generating a random projection matrix for the characteristic data with respect to the each service and the each user, and multiplying the random projection matrix by the characteristic data to generate first user random data, an encoding step of encoding the first user random data based on a preset first rule and encoding an encoded result value based on a preset second rule to generate second user random data, a random data generating step of encoding first random data, which is randomly generated and has a string form, based on a preset third rule to generate second random data, and generating encryption random data by inputting the first random data and third random data, which is randomly generated and has a string form, into a first encryption function, and a key generating step of generating encryption seed data by inputting seed data, which is extracted from the second random data and the second user random data based on a preset fourth rule, into a second encryption function and generating a user encryption key based on the encryption seed data and the encryption random data.

The method for encryption key generation and authentication for each service and each user may include the data receiving step, the pre-processing step, the characteristic data deriving step, the random projection step, the encoding step, the random data generating step, the key generating step, and the encryption key authenticating step.

In the data receiving step, the gait data may be received from the user terminal 1000, and the received gait data may be pre-processed to the pre-processed gait data in the pre-processing step.

In the characteristic data deriving step, the pre-processed gait data may be input into the first inference model and the second inference model, and the characteristic data having an intrinsic characteristic for the gait of the user and/or an intrinsic directionality for the gait of the user may be derived as a result value of the first inference model and the second inference model.

In other words, multiple pieces of characteristic data derived from multiple pieces of gait data of the same user may match each other. In addition, the gait data input in the characteristic data deriving step may have a characteristic the same as that of a random number and may be derived in the form of characteristic data assigned with unpredictability in a cipher.

In the random projection step, the characteristic data is multiplied by random projection data, which is varied depending on the each service and/or user, to generate first user random data, thereby providing a random number property to the each service and/or user.

In the encoding step, the first user random data may be encoded to second user random data.

In the random data generating step, the encryption random data necessary for generating the user encryption key may be generated. In the key generating step, the encryption seed data necessary for generating the user encryption key may be generated, and the user encryption key may be generated based on the encryption seed data and the encryption random data.

In the random data generating step and the key generating step, the user encryption key may have irreversibility making it difficult to recover the user encryption key to the gait data.

In the encryption key authenticating step, the gait data to be authenticated may be received from the user terminal 1000, and the second user random data for authentication may be derived from the gait data to be authenticated, thereby generating the authentication encryption key. When the authentication encryption key matches the user encryption key, the relevant user may be authenticated.

In other words, for the same user, the characteristic data having the intrinsic characteristic for the gait of the user and/or an intrinsic directionality for the gait of the user may be generated through the first inference model and the second inference model. Accordingly, the authentication encryption key may match the user encryption key.

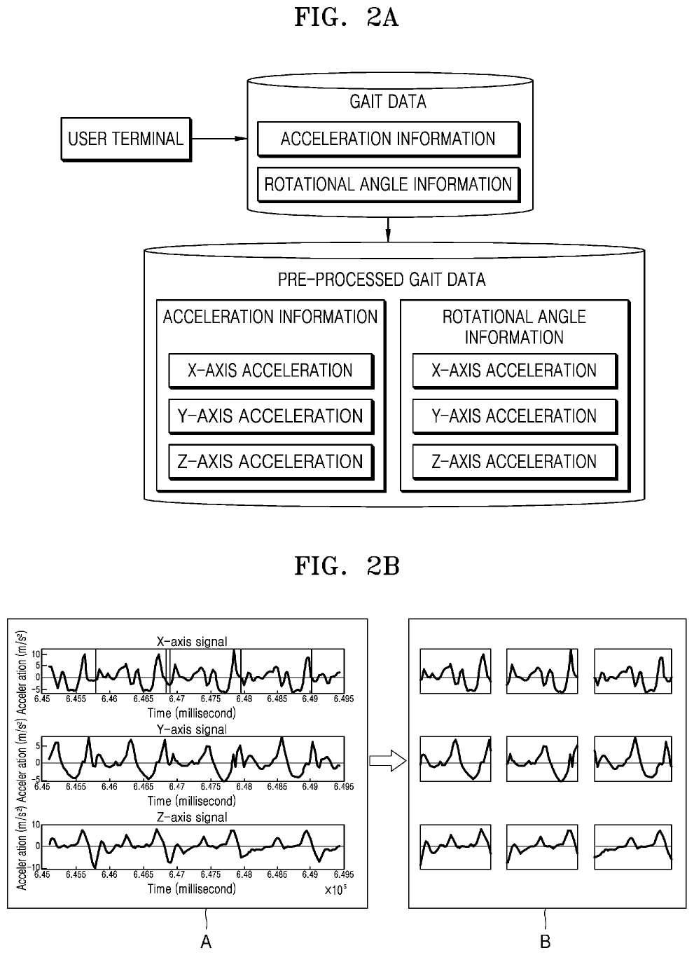

FIGS. 2A and 2B are views schematically illustrating a data receiving step and a pre-processing step according to an embodiment of the present invention.

FIG. 2A is a view illustrating gait data and pre-processed gait data according to the data receiving step and the pre-processing step.

As illustrated in FIG. 2A, the data receiving step is for receiving the gait data on the gait of the user from the user terminal 1000 including the acceleration sensor and the gyro-sensor, in which the gait data includes the data of the acceleration sensor for each time with respect to the plurality of axes and the data of the gyro-sensor for the each time with respect to the plurality of axes. The pre-processing step is for pre-processing the gait data to generate the pre-processed gait data. The data of the acceleration sensor may include acceleration information, and the data of the gyro-sensor may include rotational angle information. The pre-processed gait data may include data obtained by extracting an acceleration for each of an X axis, a Y axis, and a Z axis according to time slots, from the acceleration information, and data obtained by extracting a rotational angle for each of the X axis, the Y axis, and the Z axis according to time slots, from the rotational angle information.

In the data receiving step, the gait data, which is a measurement value for the gait of the user, may be received from the user terminal 1000. The gait data may include the acceleration information, which is data measured by the acceleration sensor, and the rotational angle information which is data measured by the gyro-sensor.

The acceleration information and the rotational angle information may correspond to time-series data, and the data may be repeated with respect to the X axis, the Y axis, and the Z axis.

In the pre-processing step, the received gait data may be pre-processed to generate the pre-processed gait data. The pre-processing may correspond to splitting the relevant data with respect to each axis and each preset time slot.

In detail, the pre-processed gait data may correspond to data obtained by extracting, from the gait data, the acceleration information and the rotational angle information for the X axis, the Y axis, and the Z axis, depending on the preset time slots, In other words, the pre-processed gait data may include, depending on the preset time slots, acceleration information for the X axis, acceleration information for the Y axis, acceleration information for the Z axis, rotational angle information for the X axis, rotational angle information for the Y axis, and rotational angle information for the Z axis.

FIG. 2B is a view illustrating the gait data and the pre-processed gait data according to an embodiment.

Reference numeral “A” of FIG. 2B may correspond to the acceleration information in the gait data. As illustrated in FIG. 2B, the gait data may include the acceleration information for each of the X axis, the Y axis, and the Z axis, and may correspond to the time-series data measured over continuous time.

Reference numeral “B” of FIG. 2B may correspond to acceleration information in the pre-processed gait data obtained by pre-processing the acceleration information in the gait data. The pre-processing may correspond to splitting the acceleration information for each of the X axis, the Y axis, and the Z axis in the gait data, depending on the preset time slots and to extracting the split acceleration information.

FIG. 2B illustrates only one embodiment for the purpose of explanation, but the gait data and the pre-processed gait data are not limited thereto.

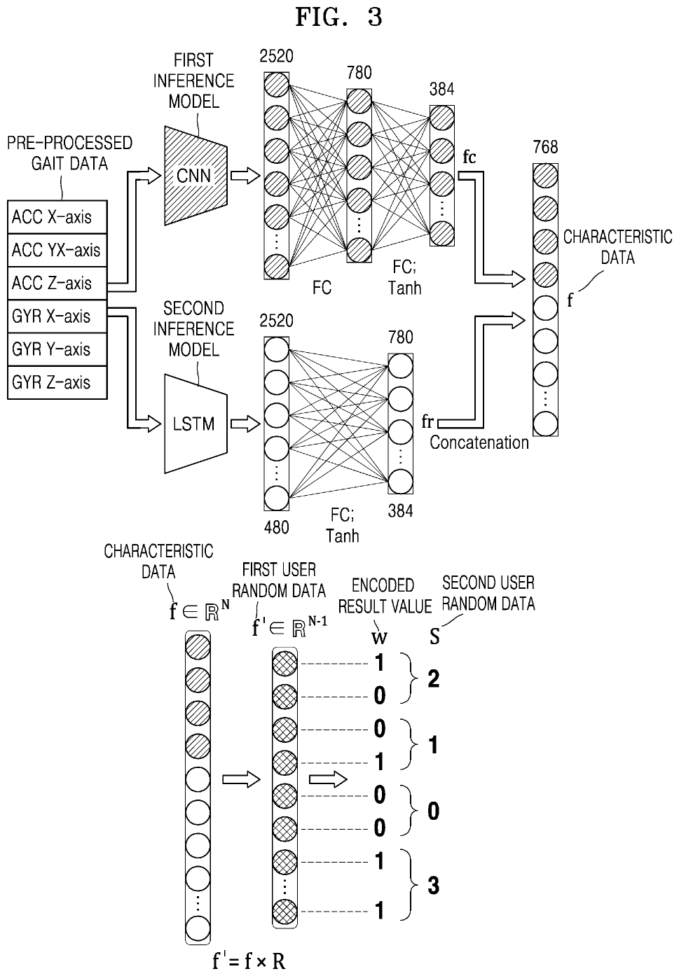

FIGS. 3A and 3B are a view schematically illustrating a characteristic data deriving step, a random projection step, and an encoding step according to an embodiment of the present invention.

FIG. 3A illustrates the characteristic data deriving step.

As illustrated in FIG. 3A, in the characteristic data deriving step, the characteristic data may be derived by inputting the pre-processed gait data into the first inference model based on the CNN and the second inference model based on the LSTM.

In the characteristic data deriving step, the characteristic data may be derived from the pre-processed gait data.

In detail, the pre-processed gait data is input into the first inference model and the second inference model, and result values are output from the first inference model and the second inference model, respectively. In this case, the combination of the result values may correspond to the characteristic data.

The first inference model, which is a model of an artificial neural network trained based on the CNN, may extract spatial features from the pre-processed gait data. The first layer of the CNN may correspond to a fully-connected (FC) layer, and may employ a rectified linear unit (ReLU) as an activation function. The second layer of the CNN may correspond to a fully-connected (FC) layer, and may employ a Hyperboic Tangent (tank) function as an activation function.

The second inference model, which is a model of an artificial neural network trained based on the LSTM, may extract temporal features from the pre-processed gait data. The LSTM may include the fully-connected (FC) layer, and may employ a tank function as an activation function.

The output values of the first inference model and the second inference model may correspond to a matrix. In other words, the characteristic data may correspond to a matrix.

FIG. 3B illustrates a random projection step and an encoding step.

As illustrated in FIG. 3B, in the random projection step, the random projection matrix for the characteristic data is randomly generated with respect to the each service and the each user, and the random projection matrix is multiplied to the characteristic data to generate first user random data. In the encoding step, the first user random data may be encoded based on a preset first rule and an encoded result value may be encoded based on a preset second rule to generate second user random data. The first rule is configured to encode into ‘1’ when a value contained in the user random data is greater than ‘0’, and to encode into ‘0’ when a value contained in the user random data is equal to or less than ‘0’. The second rule is configured to sequentially determine two pieces of data, which are contained in the user random data, as a pair and to encode into ‘0’ to ‘3’ depending on the combination of the two pieces of data

The characteristic data may be derived to the second user random data through the random projection step and the encoding step.

In detail, in the random projection step, first user random data may be generated by multiplying the random projection matrix by the characteristic data.

The random projection matrix may correspond to a matrix, and may include rows and columns to reduce the dimension of the characteristic data by one dimension. For example, when the characteristic data corresponds to a 1×9 matrix, the random projection matrix may correspond to a 9×8 matrix.

The components of the random projection matrix may be randomly generated. In detail, the components of the random projection matrix may be randomly generated with respect to each service or each user.

In other words, the characteristic data may correspond to an N-dimensional matrix, and the first user random data may correspond to an (N−1)-dimensional matrix. The first user random data may be generated to correspond to each service.

According to an embodiment of the present invention, the random projection matrix is multiplied by the characteristic data. Accordingly, various user encryption keys may be generated with respect to services, thereby enhancing security.

In the encoding step, the first user random data may be encoded to derive the second user random data.

The first user random data may be encoded based on the first rule to output a result value. The result value may correspond to a matrix including ‘0’ and ‘1’.

The first rule is to encode a relevant component (a data value) to ‘1’, when the relevant component is greater than ‘0’, and to encode the relevant component (the data value) to ‘0’, when the relevant component is equal to or less than ‘0’. The first rule may be applied to each matrix component of the first user random data.

The encoded result value may be encoded based on the second rule to be derived to the second user random data. The second user random data may correspond to the matrix including ‘0’ to ‘3’.

The second rule is configured to sequentially determine two components as a pair, with respect to a matrix row component or a matrix column component of the second user random data. The second rule is configured to encode into ‘2’, when the two components are sequentially ‘1’ and ‘0’, to encode into ‘1’, when the two components are sequentially ‘0’ and ‘1’, to encode into ‘3’ when the two components are sequentially ‘0’ an ‘0’, and to encode into ‘3’, when the two components are sequentially ‘1’ and ‘1’.

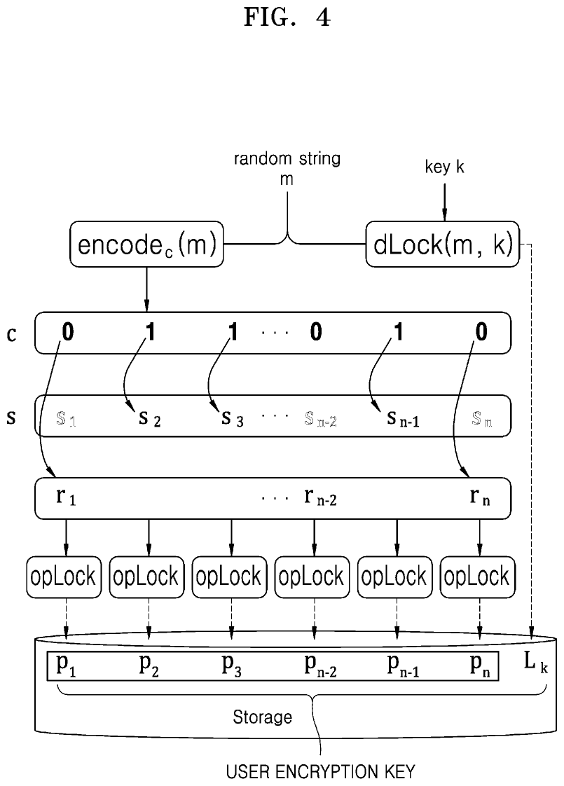

FIG. 4 is a view schematically illustrating a random data generating step and a key generating step according to an embodiment of the present invention.

As illustrated in FIG. 4, in the random data generating step, first random data, which is randomly generated and has a string form, may be encoded based on a preset third rule to generate second random data, and encryption random data may be generated by inputting the first random data and third random data, which is randomly generated and has a string form, into a first encryption function. In the key generating step, the encryption seed data may be generated by inputting seed data, which is extracted from the second random data and the second user random data based on a preset fourth rule, into a second encryption function, and a user encryption key may be generated based on the encryption seed data and the encryption random data. The fourth rule is configured to extract data at a relevant position of the seed data to data of second user random data at the relevant position when the second random data is ‘1’, and may extract the data at the relevant position of the seed data to the random data when the second random data is ‘0’.

As illustrated in FIG. 4, ‘m’ corresponds to the first random data, ‘c’ corresponds to the second random data, ‘k’ is the third random data, ‘s’ corresponds to the second user random data, ‘r’ corresponds to the seed data, ‘p’ corresponds to the encryption seed data, ‘Lk’ corresponds to encryption random data, ‘encodec’ corresponds to a third rule-based encoding, ‘dLock’ corresponds to the first encryption function, and ‘opLock’ corresponds to a second encryption function.

In the random data generating step, the second random data and the encryption random data may be generated.

In detail, in the random data generating step, the first random data and the third random data are used.

The first random data may be randomly generated and may have the form of a string, each component of which is a bit of ‘0’ or ‘1’. The first random data may be encoded to the second random data based on the third rule, and the second random data may have the form of a string, each component of which is a bit of ‘0’ or ‘1’.

The third random data may be randomly generated and may have the form of a string, each component of which is a bit of ‘0’ or ‘1’.

The first random data and the third random data may be input to the first encryption function, and the first encryption function may output encryption random data as a result value. The encryption random data may correspond to a portion of the user encryption key.

In the key generating step, the user encryption key may be generated.

Specifically, seed data may be extracted based on the fourth rule using the second random data and the second user random data.

The fourth rule corresponds to a rule for extracting components of each of the seed data, and may be determined depending on a value of each position of the component (data) of the second random data.

When the value of the component (data) of the second random data is ‘1’, the component of the seed data at the relevant position may be extracted as the component of the second user random data at the relevant position.

When the value of the component (data) of the second random data is ‘0’, the component of the seed data at the relevant position may be extracted as the component of the second user random data at the relevant position.

The seed data may be input to a second encryption function, and the second encryption function may output encryption seed data as an output value. The encryption random data may correspond to a portion of the user encryption key.

The user encryption key may be generated based on the encryption seed data and the encryption random data. Preferably, the user encryption key may correspond to a matrix formed by combining components of the encryption random data with components of the encryption seed data.

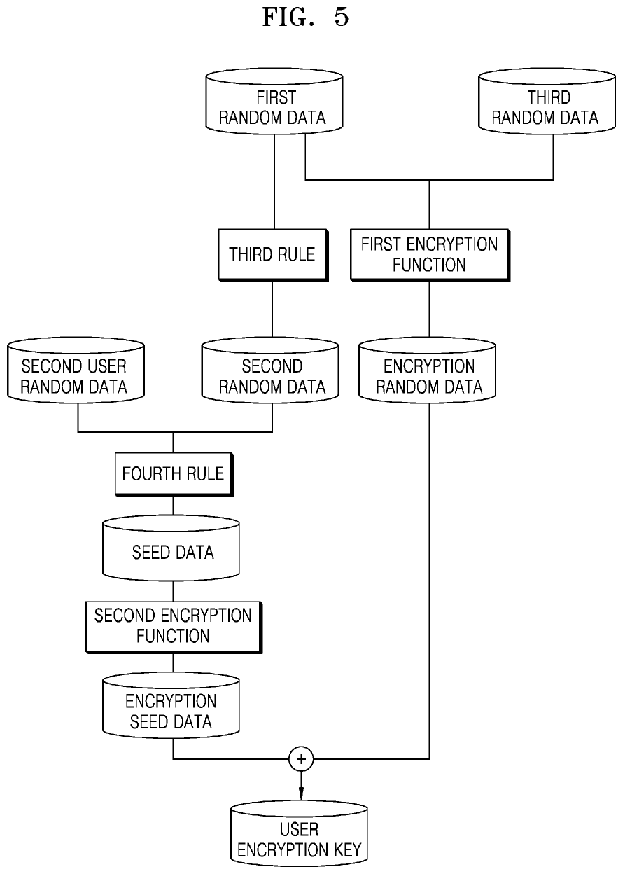

FIG. 5 is a schematically illustrating a random data generating step and a key generating step according to an embodiment of the present invention.

FIG. 5 is a view for understanding the random data generating step and the key generating step.

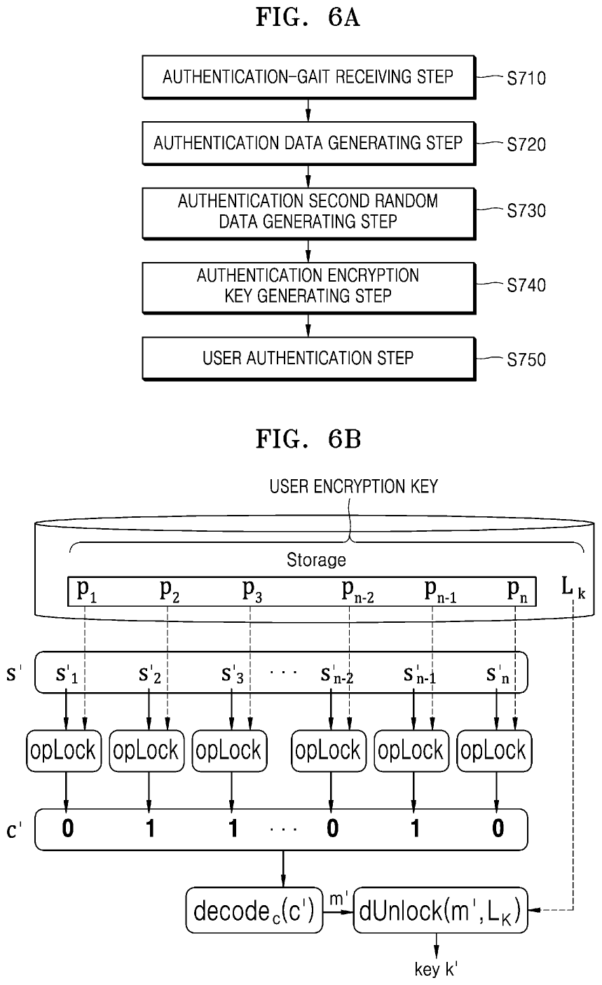

FIGS. 6A and 6B are views schematically illustrating an encryption key authenticating step according to an embodiment of the present invention.

As illustrated in FIG. 6, the method for encryption key generation and authentication, based on the gait characteristic may further include the encryption key authenticating step. The encryption key authenticating step may include an authentication-gait receiving step of receiving gait data to be authenticated with respect to the gait of a user, from the user terminal 1000, an authentication data generating step of generating authentication second user random data by processing the gait data, which is to be authenticated, through the pre-processing step, the characteristic data deriving step, the random projection step, and the encoding step, an authentication second random data generating step of generating authentication second random data by inputting the authentication second user random data and the encryption seed data into a first decryption function, an authentication encryption key generating step of extracting authentication first random data by decoding the authentication second random data based on a preset fifth rule, and generating the authentication encryption key by inputting the authentication first random data and the encryption random data into a second encryption function, and a user authentication step of determining a user as being the same user, when the authentication encryption key matches the user encryption key.

FIG. 6A illustrates a detailed step of the encryption key authenticating step.

The encryption key authenticating step, which is a step for authenticating the user, may include an authentication-gait receiving step, an authentication data generating step, an authentication-second data generating step, an authentication encryption key generating step, and a user authenticating step.

The authentication-gait receiving step may correspond to receiving gait data, which is to be authenticated, of a certain user who wants to perform authentication to use a relevant service.

The authentication data generating step may include the pre-processing step, the characteristic data deriving step, the random projection step, and the encoding step. The authentication-gait receiving step is to generate authentication-second user random data by processing the received gait data, which is to be authenticated, through the pre-processing step, the characteristic data deriving step, the random projection step, and the encoding step. The authentication-second user random data may correspond to the second user random data, for the same user.

In detail, the gait data to be authenticated may be pre-processed to pre-processed gait data to be authenticated through the pre-processing step. In the character data deriving step, the pre-processed gait data to be authenticated is input into the first inference model and the second inference model such that authentication characteristic data is extracted. In the random projection step, the authentication characteristic data is multiplied by the random projection matrix such that authentication first user random data is derived. The authentication first user random data may be encoded to authentication second user random data through the encoding step. The authentication characteristic data may correspond to characteristic data, for the same user. The random projection matrix may correspond to the random projection matrix for the relevant service.

In the authentication-second user random data generating step, authentication second random data may be generated, based on the authentication first user random data and the encryption seed data.

In the authentication encryption key generating step, the authentication first random data may be extracted from the authentication second random data, and the authentication encryption key may be generated, based on the authentication first random data and the encryption random data.

In the user authentication step, the user may be authenticated, based on the authentication encryption key generated in the authentication encryption key generating step, and the user encryption key.

Hereinafter, the details of the encryption key authenticating step will be described.

FIG. 6B illustrates the authentication second random data generating step and the authentication encryption key generating step, according to an embodiment of the present disclosure.

As illustrated in FIG. 6B, ‘p’ corresponds to the encryption seed data, ‘Lk’ corresponds to encryption random data, ‘s’ corresponds to the authentication second user random data, ‘c’ corresponds to the authentication second random data, ‘m’ corresponds to the authentication first random data, ‘opUnlock’ corresponds to the first encryption function, and ‘decodec’ corresponds to the fifth rule.

The encryption seed data generated in the key generating step may be previously stored, and the encryption seed data may be used to authenticate the user.

In the authentication second random data generating step, the encryption seed data and the authentication second user random data, which is generated in the authentication data generating step, may be input into the first encryption function, and the output value of the first encryption function may correspond to the authentication second random data. The authentication second random data may correspond to the second random data, for the same user.

In other words, since the encryption seed data is generated based on the second user random data and the second random data, the first encryption function may encrypt the encryption seed data based on the authentication second user random data, thereby extracting the authentication second random data.

In the random data generating step, the first random data is encoded based on the preset third rule to generate the second random data. To the contrary, in the authentication encryption key generating step, the authentication second random data is decoded based on the preset fifth rule, thereby extracting the authentication first random data.

The fifth rule may correspond to a rule opposite to the third rule.

The third rule may include a preset encoding scheme or function, and the fifth rule may include a preset decoding scheme or function.

In addition, in the authentication encryption key generating step, the authentication first random data and the encryption random data may be input into the second decoding function, and the second decoding function may output the authentication encryption key as a result value.

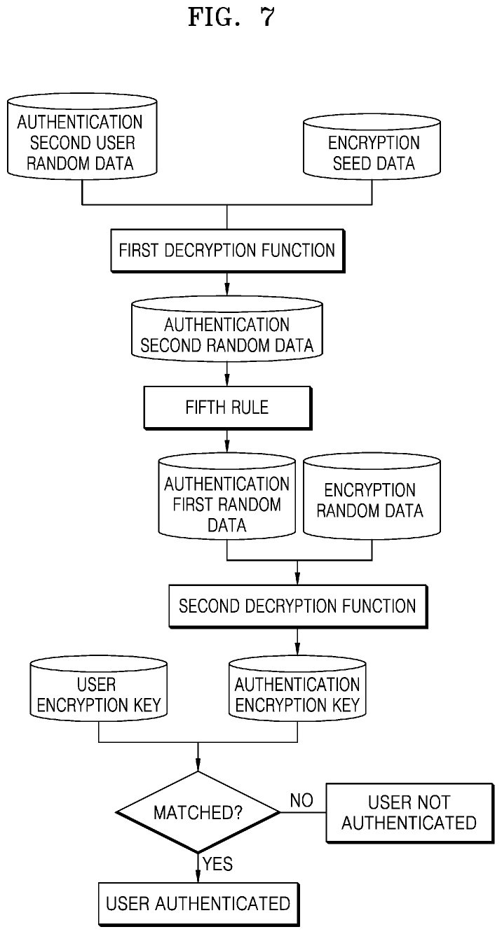

FIG. 7 is a view schematically illustrating an encryption key authenticating step according to an embodiment of the present invention.

FIG. 7 is a view for understanding the encryption key authenticating step.

As illustrated in FIG. 7, when the authentication encryption key generated in the encryption key authenticating step and the user encryption key, which is previously stored, are compared with each other and matched with each other, the user, which is a subject generating the authentication encryption key, is authenticated to use the relevant service. When the authentication encryption key generated in the encryption key authenticating step and the user encryption key are not matched with each other, the user is not authenticated such that the user is prevented from using the relevant service.

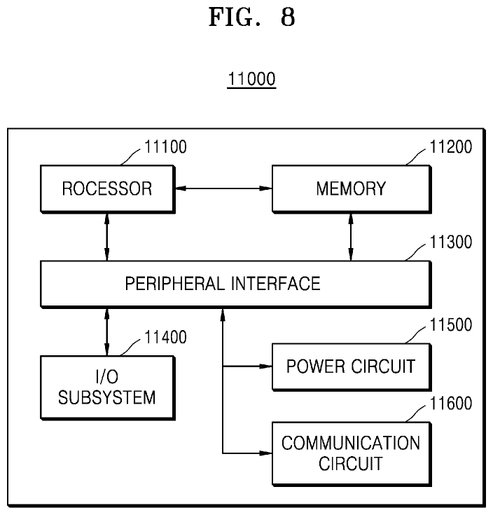

FIG. 8 schematically shows internal components of the computing device according to one embodiment of the present invention.

The user terminal 1000 shown in the above-described FIG. 1 may include components of the computing device 11000 shown in FIG. 8.

As shown in FIG. 8, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 8 is merely an example of the computing device 11000, and the computing device 11000 may have a configuration or arrangement in which some components shown in FIG. 8 are omitted, additional components not shown in FIG. 8 are further provided, or at least two components are combined. For example, a computing device for a communication terminal in a mobile environment may further include a touch screen, a sensor or the like in addition to the components shown in FIG. 8, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

As described above, according to an embodiment of the present invention, in the random data generating step and the key generating step, the characteristic data may have irreversibility. Accordingly, the characteristic data is not extracted through the user encryption key including the encryption seed data and the encryption random data, thereby protecting the biometrics of the user.

According to an embodiment of the present invention, the characteristic data having the intrinsic characteristic for the gait of the user and/or an intrinsic directionality for the gait of the user may be generated through the first inference model and the second inference model. Accordingly, the authentication encryption key and the user encryption key may be generated in match with each other, for the same user.

According to an embodiment of the present invention, a different random projection matrix is multiplied by the characteristic data, with respect to each service. Accordingly, the plurality of user encryption keys may be generated by using the characteristic data, instead of one user encryption key, thereby enhancing the security.

According to an embodiment of the present invention, since the characteristic data is input into the inference model and the encoding function, the user encryption key, which is generated through the pre-processing step, the characteristic data deriving step, the random projection step, the encoding step, and the random data generating step, may appear to be a random number.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for encryption key generation and authentication based on a gait characteristic for each user with respect to each service, the method comprising:
receiving gait data on a gait of the each user from each user terminal including an acceleration sensor and a gyro-sensor, wherein the gait data includes data of the acceleration sensor for each time with respect to a plurality of axes and data of the gyro-sensor for the each time with respect to the plurality of axes;
pre-processing the gait data to generate pre-processed gait data;
deriving characteristic data by inputting the pre-processed gait data into a first inference model based on a convolutional neural network (CNN) and a second inference model based on a long short team-memory (LSTM);
randomly generating a random projection matrix for the characteristic data with respect to the each service and the each user, and multiplying the random projection matrix by the characteristic data to generate first user random data;
encoding the first user random data based on a first rule, which is preset, and encoding an encoded result value based on a second rule, which is preset, to generate second user random data;
encoding first random data, which is randomly generated and has a string form, based on a third rule, which is preset, to generate second random data, and generating encryption random data by inputting the first random data and third random data, which is randomly generated and has a string form, into a first encryption function; and
generating encryption seed data by inputting seed data, which is extracted from the second random data and the second user random data based on a fourth rule, which is preset, into a second encryption function and generating a user encryption key based on the encryption seed data and the encryption random data.

2. The method of claim 1, further comprising:
authenticating the encryption key,
wherein the authenticating of the encryption key includes:
receiving the gait data to be authenticated with respect to the gait of the each user, from the each user terminal;
generating authentication second user random data by processing the gait data, which is to be authenticated, through the pre-processing, the characteristic data deriving, the randomly generating of the random projection matrix, and the encoding;
generating authentication second random data by inputting the authentication second user random data and the encryption seed data into a first decryption function;
extracting authentication first random data by decoding the authentication second random data based on a fifth rule, which is preset, and generating the authentication encryption key by inputting the authentication first random data and the encryption random data into a second encryption function; and
determining the user as a same user, when the authentication encryption key matches the user encryption key.

3. The method of claim 1, wherein the data of the acceleration sensor includes acceleration information, the data of the gyro-sensor includes rotational angle information, and
the pre-processed gait data includes data obtained by extracting an acceleration for each of an X axis, a Y axis, and a Z axis according to time slots, from the acceleration information, and data obtained by extracting a rotational angle for each of the X axis, the Y axis, and the Z axis according to the time slots, from the rotational angle information.

4. The method of claim 1, wherein the first rule is configured to encode into ‘1’ when a value contained in the user random data is greater than ‘0’, and to encode into ‘0’ when a value contained in the user random data is equal to or less than ‘0’.

5. The method of claim 1, wherein the second rule is configured to sequentially determine two pieces of data, which are contained in the user random data, as a pair and to encode into ‘0’ to ‘3’ depending on combination of the two pieces of data.

6. The method of claim 1, wherein the fourth rule is configured to extract data at a relevant position of the seed data as the second user random data at the relevant position when the second random data is ‘1’, and extract the data at the relevant position of the seed data as random data when the data of the second random data is ‘0’.
